(19) United States
(12) Patent Application Publication
(10) Pub. No.: US 2020/0175426 A1
(43) Pub. Date: Jun. 4, 2020

(54) DATA-BASED PREDICTION RESULTS USING DECISION FORESTS

(71) Applicant: Alibaba Group Holding Limited, George Town (KY)

(72) Inventors: Lichun Li, Hangzhou (CN); Jinsheng Zhang, Hangzhou (CN); Huazhong Wang, Hanzghou (CN)

(73) Assignee: Alibaba Group Holding Limited, George Town (KY)

(21) Appl. No.: 16/779,534

(22) Filed: Jan. 31, 2020

Related U.S. Application Data
(63) Continuation of application No. PCT/CN2020/071099, filed on Jan. 9, 2020.

(30) Foreign Application Priority Data
Jul. 1, 2019 (CN) 201910583550.3

(51) Int. Cl. G06N 20/20; H04L 9/00

(52) U.S. Cl. CPC G06N 20/20; H04L 9/008

(57) ABSTRACT

Implementations of the present specification provide a data processing method and apparatus, and an electronic device. The method includes the following: obtaining a target leaf node that matches business data based on an encryption decision forest, where the encryption decision forest includes at least one decision tree, a splitting node of the decision tree corresponds to plaintext data of a splitting condition, a leaf node of the decision tree corresponds to ciphertext data of a leaf value, and the ciphertext data is obtained by encrypting the leaf value by a homomorphic encryption algorithm; and sending ciphertext data corresponding to the target leaf node to a first device.

### CROSS-REFERENCE TO RELATED APPLICATIONS

This application is a continuation of PCT Application No. PCT/CN2020/071099, filed on Jan. 9, 2020, which claims priority to Chinese Patent Application No. 201910583550.3, filed on Jul. 1, 2019, and each application is hereby incorporated by reference in its entirety.

### TECHNICAL FIELD

Implementations of the present specification relate to the field of computer technologies, and in particular to a data processing method and apparatus, and an electronic device.

### BACKGROUND

In business practice, usually, one party owns a model that needs to be kept confidential (hereinafter referred to as a model party) and the other party owns business data that needs to be kept confidential (hereinafter referred to as a data party). How to enable the model party to obtain a prediction result after the business data is predicted based on the model without leaking the model of the model party and without leaking the business data of the data party is a technical problem to be urgently solved at present.

### SUMMARY

An objective of implementations of the present specification is to provide a data processing method and apparatus, and an electronic device, so that a first device obtains a prediction result after business data is predicted based on an original decision forest without leaking the original decision forest of the first device and without leaking the business data of a second device.

To achieve the previous objective, one or more implementations of the present specification provide the following technical solutions:

According to a first aspect of one or more implementations of the present specification, a data processing method is provided, where the method is applied to a first device and includes the following: keeping a splitting condition corresponding to a splitting node of a decision tree in an original decision forest unchanged, and encrypting a leaf value corresponding to a leaf node of the decision tree in the original decision forest by using a homomorphic encryption algorithm to obtain an encryption decision forest; and sending the encryption decision forest to a second device.

According to a second aspect of one or more implementations of the present specification, a data processing apparatus is provided, where the apparatus is applied to a first device and includes the following: an encryption unit, configured to keep a splitting condition corresponding to a splitting node of a decision tree in an original decision forest unchanged, and encrypt a leaf value corresponding to a leaf node of the decision tree in the original decision forest by using a homomorphic encryption algorithm to obtain an encryption decision forest; and a sending unit, configured to send the encryption decision forest to a second device.

According to a third aspect of one or more implementations of the present specification, an electronic device is provided, where the electronic device includes the following: a memory, configured to store a computer instruction; and a processor, configured to execute the computer instruction to implement the method steps according to the first aspect.

According to a fourth aspect of one or more implementations of the present specification, a data processing method is provided, where the method is applied to a second device and includes the following: obtaining a target leaf node that matches business data based on an encryption decision forest, where the encryption decision forest includes at least one decision tree, a splitting node of the decision tree corresponds to plaintext data of a splitting condition, a leaf node of the decision tree corresponds to ciphertext data of a leaf value, and the ciphertext data is obtained by encrypting the leaf value by a homomorphic encryption algorithm; and sending ciphertext data corresponding to the target leaf node to a first device.

According to a fifth aspect of one or more implementations of the present specification, a data processing apparatus is provided, where the apparatus is applied to a second device and includes the following: an acquisition unit, configured to: obtain a target leaf node that matches business data based on an encryption decision forest, where the encryption decision forest includes at least one decision tree, a splitting node of the decision tree corresponds to plaintext data of a splitting condition, a leaf node of the decision tree corresponds to ciphertext data of a leaf value, and the ciphertext data is obtained by encrypting the leaf value by a homomorphic encryption algorithm; and a sending unit, configured to send ciphertext data corresponding to the target leaf node to a first device.

According to a sixth aspect of one or more implementations of the present specification, an electronic device is provided, where the electronic device includes the following: a memory, configured to store a computer instruction; and a processor, configured to execute the computer instruction to implement the method steps according to the fourth aspect.

As can be seen from the technical solutions provided in the previous implementations of the present specification, in the implementations of the present specification, by using the encryption decision forest, the second device can obtain the target leaf node that matches the business data; and by using the target leaf node, the second device can further obtain the prediction result after the business data is predicted based on the decision forest, or obtain the comparison result between the prediction result after the business data is predicted based on the decision forest and the predetermined threshold. Because the encryption decision forest is used, in the previous process, the first device does not need to leak its own original decision forest, and the second device does not need to leak its own business data.

### BRIEF DESCRIPTION OF DRAWINGS

To describe technical solutions in implementations of the present specification or in the existing technology more clearly, the following briefly describes the accompanying drawings needed for describing the implementations or the existing technology. Clearly, the accompanying drawings in the following descriptions merely show some implementations of the present specification, and a person of ordinary skill in the art can still derive other drawings from these accompanying drawings without creative efforts.

FIG. 1 is a schematic structural diagram illustrating a decision tree, according to an implementation of the present specification;

FIG. 2 is a flowchart illustrating a data processing method, according to an implementation of the present specification;

FIG. 3 is a schematic structural diagram illustrating a full binary tree, according to an implementation of the present specification;

FIG. 4 is a flowchart illustrating a data processing method, according to an implementation of the present specification;

FIG. 5 is a schematic diagram illustrating a data processing method, according to an implementation of the present specification;

FIG. 6 is a flowchart illustrating a data processing method, according to an implementation of the present specification;

FIG. 7 is a schematic diagram illustrating a functional structure of a data processing apparatus, according to an implementation of the present specification;

FIG. 8 is a schematic diagram illustrating a functional structure of a data processing apparatus, according to an implementation of the present specification;

FIG. 9 is a schematic diagram illustrating a functional structure of a data processing apparatus, according to an implementation of the present specification; and

FIG. 10 is a schematic diagram illustrating a functional structure of an electronic device, according to an implementation of the present specification.

### DESCRIPTION OF IMPLEMENTATIONS

The following clearly describes the technical solutions in the implementations of the present specification with reference to the accompanying drawings in the implementations of the present specification. Clearly, the described implementations are merely some but not all of the implementations of the present specification. All other implementations obtained by a person of ordinary skill in the art based on the implementations of the present specification without creative efforts shall fall within the protection scope of the present specification. In addition, it should be understood that although terms “first”, “second”, “third”, etc. can be used in the present specification to describe various types of information, the information should not be limited by these terms. These terms are only used to differentiate between information of the same type. For example, without departing from the scope of the present specification, first information can also be referred to as second information, and similarly, the second information can also be referred to as the first information.

To help a person skilled in the art understand the technical solutions in the implementations of the present specification, the following first describes the technical terms used in the implementations of the present specification.

Decision tree: a machine learning model under supervision. The decision tree can be a binary tree, etc. The decision tree includes multiple nodes. The multiple nodes can form multiple prediction paths. A start node of the prediction path is the root node of the decision tree, and an end node is a leaf node of the decision tree.

The decision tree can include a regression decision tree and a classification decision tree. A prediction result of the regression decision tree can be a specific value. A prediction result of the classification decision tree can be a specific category. It is worthwhile to note that, for ease of calculation, a vector can usually be used to represent a category. For example, a vector [1 0 0] can represent category A, a vector [0 1 0] can represent category B, and a vector [0 0 1] can represent category C. Certainly, the vector here is merely an example. In practice, a category can also be represented by using other mathematical methods.

Splitting node: When a node in a decision tree can be split downwards, the node can be referred to as a splitting node. The splitting node can include the root node and other nodes (hereinafter referred to as ordinary nodes) other than a leaf node and the root node. The splitting node corresponds to a splitting condition and the splitting condition can be used to select a prediction path.

Leaf node: When a node in a decision tree cannot be split downwards, the node can be referred to as a leaf node. The leaf node corresponds to a leaf value. The leaf values corresponding to different leaf nodes of the decision tree can be the same or different. Each leaf value can represent one prediction result. The leaf value can be a value, a vector, etc. For example, a leaf value corresponding to a leaf node of the regression decision tree can be a value, and a leaf value corresponding to a leaf node of the classification decision tree can be a vector.

Full binary tree: When each of all nodes at each layer except the last layer of a binary tree is split into two sub-nodes, the binary tree can be referred to as a full binary tree.

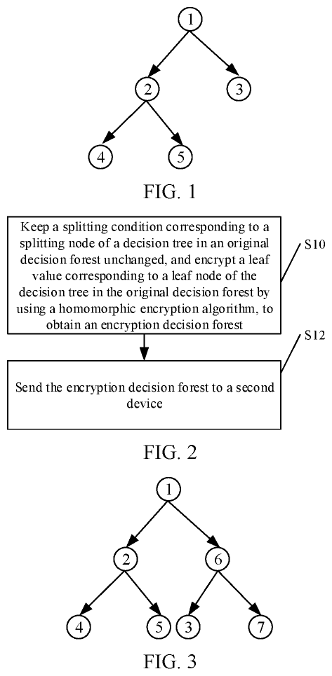

To facilitate understanding of the previous terms, the following describes an example scenario. References are made to FIG. 1. In the example scenario, a decision tree Tree1 can include five nodes: nodes 1, 2, 3, 4, and 5. Node 1 is the root node. Nodes 1 and 2 are ordinary nodes. Nodes 3, 4, and 5 are leaf nodes. Node 1, node 2, and node 4 can form one prediction path. Node 1, node 2, and node 5 can form another prediction path. Node 1 and node 3 can form another prediction path.

The splitting conditions corresponding to node 1, node 2, and node 3 are shown in Table 1.

TABLE 1

| Node | Splitting condition |
|---|---|
| Node 1 | Older than 20 years |
| Node 2 | Annual income over 50,000 |

The leaf values corresponding to node 3, node 4, and node 5 are shown in Table 2.

TABLE 2

| Node | Leaf value |
|---|---|
| Node 3 | 200 |
| Node 4 | 700 |
| Node 5 | 500 |

The splitting conditions “older than 20 years” and “annual income over 50,000” can be used to select a prediction path. When the splitting condition is satisfied, the prediction path on the left can be selected. When the splitting condition is unsatisfied, the prediction path on the right can be selected. For node 1, when the splitting condition “older than 20 years” is satisfied, the prediction path on the left can be selected, and then node 2 can be jumped to. When the splitting condition “older than 20 years” is unsatisfied, the prediction path on the right can be selected, and then node 3 can be jumped to. For node 2, when the splitting condition “annual income over 50,000” is satisfied, the prediction path on the left can be selected, and then node 4 can be jumped to. When the splitting condition “annual income over 50,000” is unsatisfied, the prediction path on the right can be selected, and then node 5 can be jumped to.

One or more decision trees can form a decision forest. Algorithms for integrating multiple decision trees into a decision forest can include Random Forest, Extreme Gradient Boosting (XGBoost), and Gradient Boosting Decision Tree (GBDT). The decision forest is a machine learning model under supervision, and can include a regression decision forest and a classification decision forest. The regression decision forest can include one or more regression decision trees. When the regression decision forest includes one regression decision tree, a prediction result of the regression decision tree can be used as a prediction result of the regression decision forest. When the regression decision forest includes multiple regression decision trees, summation can be performed on prediction results of the multiple regression decision trees, and a summation result can be used as a prediction result of the regression decision forest. The classification decision forest can include one or more classification decision trees. When the classification decision forest includes one classification decision tree, a prediction result of the classification decision tree can be used as a prediction result of the classification decision forest. When the classification decision forest includes multiple classification decision trees, statistics calculation can be performed on prediction results of the multiple classification decision trees, and a statistical result can be used as a prediction result of the classification decision forest. It is worthwhile to note that, in some scenarios, a prediction result of a classification decision tree can be a vector that can be used to represent a category. As such, summation can be performed on vectors predicted for multiple classification decision trees in the classification decision forest, and a summation result can be used as a prediction result of the classification decision forest. For example, a certain classification decision forest can include classification decision trees Tree2, Tree3, and Tree4. A prediction result of Tree2 can be a vector [1 0 0], and the vector [1 0 0] represents category A. A prediction result of Tree3 can be a vector [0 1 0] and the vector [0 1 0] represents category B. A prediction result of Tree4 can be a vector [1 0 0], and the vector [0 0 1] represents category C. Then, summation can be performed on the vectors [1 0 0] [0 1 0], and [1 0 0] [2 1 0], to obtain a vector which is used as the prediction result of the classification decision forest. The vector [2 1 0] represents that, in the classification decision forest, the number of times that the prediction results in category A is 2 times, the number of times that the prediction results in category B is 1 time, and the number of times that the prediction results in category C is 0 times.

The implementations of the present specification provide a data processing system. The data processing system can include a first device and a second device. The first device can be a device such as a server, a mobile phone, a tablet computer, or a personal computer, or may be a system comprising of multiple devices, for example, a server cluster comprising of multiple servers. The first device owns a decision forest that needs to be kept confidential. The second device can be a device such as a server, a mobile phone, a tablet computer, or a personal computer, or can be a system comprising of multiple devices, for example, a server cluster comprising of multiple servers. The second device owns business data that needs to be kept confidential, and the business data can be, for example, transaction data, loan data, etc.

The first device and the second device can perform cooperative calculation, so that the first device obtains a prediction result after the business data is predicted based on the decision forest. In such process, the first device cannot leak its own decision forest, and the second device cannot leak its own business data. In an example scenario, the first device belongs to a financial institution. The second device belongs to a data institution, such as a big data company, a government agency, etc. The financial institution can use the business data of the data institution to evaluate the credit of an individual user.

Based on the data processing system, the present specification provides an implementation of the data processing method. In practice, the present implementation can be applied to the preprocessing stage. References are made to FIG. 2. The implementation takes the first device as the execution body, and can include the following steps.

S10: Keep a splitting condition corresponding to a splitting node of a decision tree in an original decision forest unchanged, and encrypt a leaf value corresponding to a leaf node of the decision tree in the original decision forest by using a homomorphic encryption algorithm, to obtain an encryption decision forest.

In some implementations, for ease of distinction, the decision forest before encryption processing can be referred to as an original decision forest, and the decision forest after encryption processing can be referred to as an encryption decision forest. In the original decision forest, a splitting node of a decision tree corresponds to plaintext data of a splitting condition, and a leaf node of the decision tree corresponds to plaintext data of a leaf value. In the encryption decision forest, a splitting node of a decision tree corresponds to plaintext data of a splitting condition, and a leaf node of the decision tree corresponds to ciphertext data of a leaf value. The ciphertext data is obtained by encrypting the leaf value by a homomorphic encryption algorithm.

In some implementations, the first device can keep a splitting condition corresponding to a splitting node of a decision tree in an original decision forest unchanged, and encrypt a leaf value corresponding to a leaf node of the decision tree in the original decision forest by using a homomorphic encryption algorithm, to obtain an encryption decision forest. Any type of homomorphic encryption algorithm can be used here to encrypt the leaf value, provided that the homomorphic encryption algorithm can support addition homomorphism. In practice, the leaf value can be encrypted by using a homomorphic encryption algorithm such as the Paillier algorithm, the Okamoto-Uchiyama algorithm, or the Damgard-Jurik algorithm. In an example scenario, the first device can own a public-private key pair for homomorphic encryption, and can encrypt the leaf value by using the homomorphic encryption algorithm and the public key in the public-private key pair.

S12: Send the encryption decision forest to a second device.

In some implementations, the first device can send the encryption decision forest to the second device so that the second device predicts business data based on the encryption decision forest. As such, the second device can obtain the plaintext data of the splitting condition corresponding to the splitting node of the decision tree in the original decision forest, but cannot obtain the plaintext data of the leaf value corresponding to the leaf node of the decision tree in the original decision forest, thereby protecting privacy of the original decision forest. It is worthwhile to note that, the sending of the encryption decision forest to the second device by the first device here can include the following: The first device sends, to the second device, a location identifier of a splitting node, plaintext data of a splitting condition corresponding to the splitting node, a location identifier of a leaf node, and ciphertext data of a leaf value corresponding to the leaf node of each decision tree in the encryption decision forest. The location identifier of the node can be used to identify the location of the node in the decision tree. For example, the location identifier can be the number of the node, etc.

In some implementations, one or more decision trees in the original decision forest are non-full binary trees. As such, before S10, the first device can further add a false node to the decision tree of the non-full binary tree so that the decision tree forms a full binary tree. As such, a structure of a decision tree in the original decision forest can be hidden, thereby enhancing privacy protection for the original decision forest. References are made to FIG. 3. The decision tree Tree1 shown in FIG. 1 is a non-full binary tree. False node 6 and false node 7 can be added to the decision tree Tree1 shown in FIG. 1. A splitting condition corresponding to node 6 can be randomly generated, or can be generated based on a specific policy. A leaf value corresponding to node 7 can be the same as a leaf value corresponding to node 3.

In some implementations, before S10, the first device can also add one or more false decision trees to the original decision forest. As such, privacy protection for the original decision forest can be enhanced. The number of layers of a false decision tree can be the same as or different from the number of layers of a real decision tree in the original decision forest. A splitting condition corresponding to a splitting node of a false decision tree can be randomly generated, or can be generated based on a specific policy. A leaf value corresponding to a leaf node of a false decision tree can be a specific value such as 0.

Further, after a false decision tree is added, the first device can further disorder the decision trees in the original decision forest. As such, the second device can be prevented from speculating which decision trees are real decision trees and which decision trees are false decision trees in a later process based on an arrangement order of decision trees in the encryption decision forest.

According to the data processing method in the implementations of the present specification, the first device can send the encryption decision forest to the second device. As such, on the one hand, privacy protection for the original decision forest is implemented. On the other hand, the second device can predict business data based on the encryption decision forest.

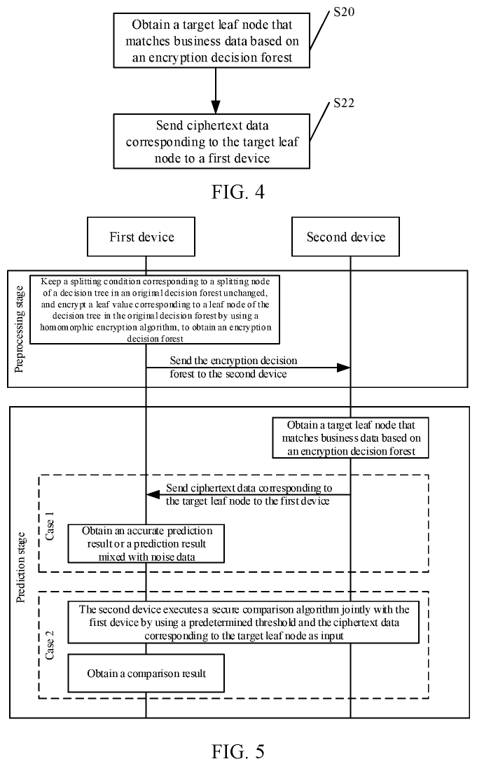

Based on the data processing system, the present specification provides another implementation of the data processing method. In practice, the present implementation can be applied to the prediction stage. Further references are made to FIG. 4 and FIG. 5. The implementation takes the second device as the execution body, and can include the following steps.

S20: Obtain a target leaf node that matches business data based on an encryption decision forest.

In some implementations, the first device can send the encryption decision forest to the second device. The second device can receive the encryption decision forest. The encryption decision forest can include at least one decision tree. In the encryption decision forest, a splitting node of a decision tree corresponds to plaintext data of a splitting condition, and a leaf node of the decision tree corresponds to ciphertext data of a leaf value. The ciphertext data is obtained by encrypting the leaf value by a homomorphic encryption algorithm.

In some implementations, the second device can obtain a prediction path that matches the business data from each decision tree of the encryption decision forest, and can use a leaf node in the prediction path as the target leaf node that matches the business data in the decision tree.

S22: Send ciphertext data corresponding to the target leaf node to a first device.

In some implementations, the encryption decision forest can include one decision tree so that there is one target leaf node. As such, the second device can directly send ciphertext data corresponding to the target leaf node to a first device. The first device can receive the ciphertext data corresponding to the target leaf node, and can decrypt the received ciphertext data to obtain a leaf value corresponding to the target leaf node. To be specific, an accurate prediction result is obtained. In an example scenario, the first device can own a public-private key pair for homomorphic encryption, and can decrypt the received ciphertext data by using the private key in the public-private key pair.

Alternatively, the second device can further perform summation on the ciphertext data corresponding to the target leaf node and noise data to obtain a first summation result, and can send the first summation result to the first device. The first device can receive the first summation result, and can decrypt the first summation result to obtain corresponding plaintext data. To be specific, a prediction result mixed with noise data is obtained. A size of the noise data can be flexibly set depending on an actual demand, and is usually smaller than the business data. The second device can obtain the first summation result by using any feasible method. In an example scenario, the first device can own a public-private key pair for homomorphic encryption, and the second device can own the public key in the public-private key pair. The ciphertext data corresponding to the target leaf node can be represented as E(u), and the noise data can be represented as s. The second device can encrypt the noise data s by using the public key and the homomorphic encryption algorithm to obtain E(s), and can perform summation on E(u) and E(s) to obtain E(u)+E(s)=E(u+s). To be specific, the first summation result is obtained. Alternatively, the second device can generate the first summation result E(u+s) directly based on E(u) and the noise data s by using the public key and the homomorphic encryption algorithm.

In some implementations, the encryption decision forest can include multiple decision trees so that there are multiple target leaf nodes. As such, the second device can further perform summation on the ciphertext data corresponding to the multiple target leaf nodes to obtain a second summation result, and can send the second summation result to the first device. The first device can receive the second summation result, and can decrypt the second summation result to obtain corresponding plaintext data. To be specific, an accurate prediction result is obtained. For a process of decrypting the second summation result by the first device, references can be made to the previous process of decrypting the ciphertext data corresponding to the target leaf node, and details are omitted here for simplicity.

Alternatively, the second device can further perform summation on the second summation result and the noise data to obtain a third summation result, and can send the third summation result to the first device. The first device can receive the third summation result, and can decrypt the third summation result to obtain corresponding plaintext data. To be specific, a prediction result mixed with noise data is obtained. For a process of obtaining the third summation result by the second device, references can be made to the previous process of obtaining the first summation result, and details are omitted here for simplicity.

According to the data processing method in the implementations of the present specification, the second device can obtain the target leaf node that matches the business data based on the encryption decision forest, and can send the ciphertext data corresponding to the target leaf node to the first device. As such, the first device can obtain the prediction result after the business data is predicted based on the decision forest without leaking the decision forest of the first device and without leaking the business data of the second device.

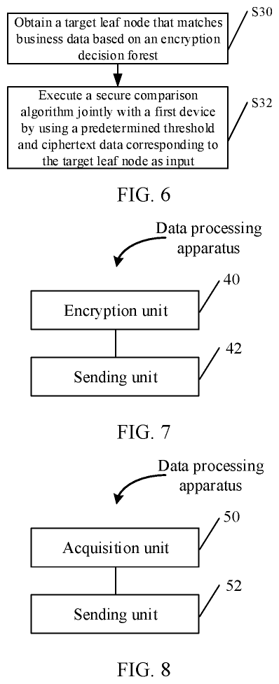

Based on the data processing system, the present specification provides another implementation of the data processing method. In practice, the present implementation can be applied to the prediction stage. Further references are made to FIG. 5 and FIG. 6. The implementation takes the second device as the execution body, and can include the following steps.

S30: Obtain a target leaf node that matches business data based on an encryption decision forest.

For a process of obtaining the target leaf node by the second device, references can be made to the previous implementations, and details are omitted here for simplicity.

S32: Execute a secure comparison algorithm jointly with a first device by using a predetermined threshold and ciphertext data corresponding to the target leaf node as input.

In some implementations, a size of the predetermined threshold can be flexibly set depending on an actual demand. In practice, the predetermined threshold can be a critical value. When the prediction result is greater than the predetermined threshold, the first device can perform a predetermined operation. When the prediction result is less than the predetermined threshold, the first device can perform another predetermined operation. For example, the predetermined threshold can be a critical value in a risk assessment business. When a predicted credit score for a certain user is greater than the predetermined threshold, it indicates that the user has a high risk level, and the first device can refuse to perform an operation of lending to the user. When the predicted credit score for a certain user is less than the threshold, it indicates that the user has a low risk level, and the first device can perform an operation of lending to the user.

In some implementations, the encryption decision forest can include one decision tree so that there is one target leaf node. As such, the second device can directly use the predetermined threshold and the ciphertext data corresponding to the target leaf node as input, and the first device can use the private key for homomorphic encryption as input, to jointly execute a secure comparison algorithm. By executing the secure comparison algorithm, the first device can obtain a first comparison result without leaking the ciphertext data corresponding to the target leaf node of the second device. The first comparison result is used to indicate a magnitude relationship between a leaf value corresponding to the target leaf node and the predetermined threshold.

Any type of secure comparison algorithm can be used here. For example, the first device can own a public-private key pair for homomorphic encryption, and the second device can own the public key in the public-private key pair. The ciphertext data corresponding to the target leaf node can be represented as E(u), and the predetermined threshold can be represented as t. The second device can generate a positive random number r, can generate E(r(u−t)) by using a homomorphic encryption algorithm based on the public key, and can send E(r(u−t)) to the first device. The first device can receive E(r(u−t)), can decrypt E(r(u−t)) based on the private key to obtain corresponding plaintext data r(u−t), and can determine the first comparison result based on a positive or negative value of r(u−t). When r(u−t) is a positive number, the first device can determine that the leaf value corresponding to the target leaf node is greater than the predetermined threshold. When r(u−t) is a negative number, the first device can determine that the leaf value corresponding to the target leaf node is less than the predetermined threshold. For another example, the first device can own a public-private key pair for homomorphic encryption, and the second device can own the public key in the public-private key pair. The ciphertext data corresponding to the target leaf node can be represented as E(u), and the predetermined threshold can be represented as t. The second device can generate a positive random number p, can generate E(u+p) by using a homomorphic encryption algorithm based on the public key, and can send E(u+p) to the first device. The first device can receive E(u+p), and can decrypt E(u+p) based on the private key to obtain u+p. As such, the first device and the second device can jointly execute a multi-party secure comparison algorithm based on i=u+p and j=t+p that are held by the first device and the second device, respectively. By executing the multi-party secure comparison algorithm, the first device can obtain a first comparison result. The first comparison result can represent a magnitude relationship between i and j, and can further represent a magnitude relationship between u and t. During the execution of the multi-party secure comparison algorithm, the first device cannot leak its own i and the second device cannot leak its own j.

In some implementations, the encryption decision forest can include multiple decision trees so that there are multiple target leaf nodes. As such, the second device can further perform summation on ciphertext data corresponding to the multiple target leaf nodes to obtain a summation result. The second device can use the predetermined threshold and the summation result as input, and the first device can use the private key for homomorphic encryption as input, to jointly execute a secure comparison algorithm. By executing the secure comparison algorithm, the first device can obtain a second comparison result without leaking the summation result of the second device. The second comparison result is used to indicate a magnitude relationship between plaintext data corresponding to the summation result and the predetermined threshold. For a process of executing the secure comparison algorithm, references can be made to the previous implementations, and details are omitted here for simplicity.

According to the data processing method in the implementations of the present specification, the second device can obtain the target leaf node that matches the business data based on the encryption decision forest, and can execute the secure comparison algorithm jointly with the first device by using the predetermined threshold and the ciphertext data corresponding to the target leaf node as input, so that the first device obtains the comparison result. The comparison result is used to indicate a magnitude relationship between the prediction result and the predetermined threshold. As such, the first device can obtain a comparison result between the predetermined threshold and the prediction result after the business data is predicted based on the decision forest without leaking the decision forest of the first device and without leaking the business data of the second device.

References are made to FIG. 7. The present specification further provides an implementation of a data processing apparatus. The present implementation can be applied to the first device, and can include the following units: an encryption unit 40, configured to keep a splitting condition corresponding to a splitting node of a decision tree in an original decision forest unchanged, and encrypt a leaf value corresponding to a leaf node of the decision tree in the original decision forest by using a homomorphic encryption algorithm, to obtain an encryption decision forest; and a sending unit 42, configured to send the encryption decision forest to a second device.

References are made to FIG. 8. The present specification further provides an implementation of a data processing apparatus. The present implementation can be applied to the second device, and can include the following units: an acquisition unit 50, configured to: obtain a target leaf node that matches business data based on an encryption decision forest, where the encryption decision forest includes at least one decision tree, a splitting node of the decision tree corresponds to plaintext data of a splitting condition, a leaf node of the decision tree corresponds to ciphertext data of a leaf value, and the ciphertext data is obtained by encrypting the leaf value by a homomorphic encryption algorithm; and a sending unit 52, configured to send ciphertext data corresponding to the target leaf node to a first device.

References are made to FIG. 9. The present specification further provides an implementation of a data processing apparatus. The present implementation can be applied to the second device, and can include the following units: an acquisition unit 60, configured to: obtain a target leaf node that matches business data based on an encryption decision forest, where the encryption decision forest includes at least one decision tree, a splitting node of the decision tree corresponds to plaintext data of a splitting condition, a leaf node of the decision tree corresponds to ciphertext data of a leaf value, and the ciphertext data is obtained by encrypting the leaf value by a homomorphic encryption algorithm; and a comparison unit 62, configured to execute a secure comparison algorithm jointly with a first device by using a predetermined threshold and ciphertext data corresponding to the target leaf node as input, so that the first device obtains a first comparison result, where the first comparison result is used to indicate a magnitude relationship between a leaf value corresponding to the target leaf node and the predetermined threshold.

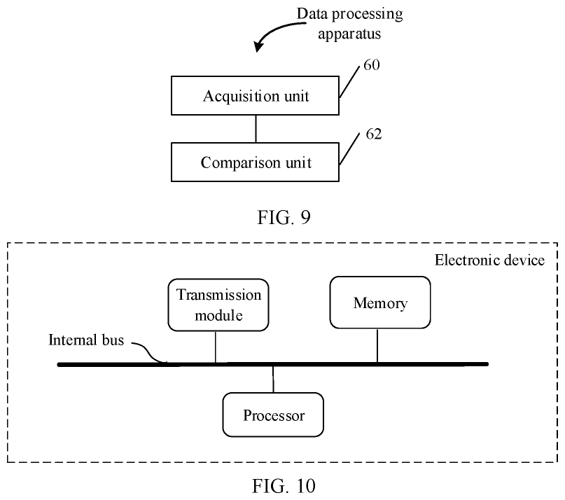

The following describes an implementation of an electronic device in the present specification. FIG. 10 is a schematic diagram of a hardware structure of an electronic device in the implementation. As shown in FIG. 10, the electronic device can include one or more processors (only one processor is shown in the figure), one or more memories, and one or more transmission modules. Certainly, a person of ordinary skill in the art can understand that the hardware structure shown in FIG. 10 is merely an example, and does not limit the hardware structure of the previous electronic device. In practice, the electronic device can further include more or less components or units than those shown in FIG. 10, or can have a configuration different from that shown in FIG. 10.

The memory can include a high-speed random access memory, or can further include non-volatile memories, such as one or more magnetic storage devices, flash memories, or other non-volatile solid-state memories. Certainly, the memory can further include a remotely disposed network memory. The remotely disposed network memory can be connected to the electronic device by using a network such as the Internet, an intranet, a local area network, or a mobile communications network. The memory can be configured to store a program instruction or module of application software, for example, a program instruction or module of the implementation corresponding to FIG. 2, a program instruction or module of the implementation corresponding to FIG. 4, or a program instruction or module of the implementation corresponding to FIG. 6 in the present specification.

The processor can be implemented in any suitable methods. For example, the processor can take the form of, for example, a microprocessor or processor, a computer readable medium storing computer readable program code (such as software or firmware) executable by the microprocessor or processor, a logic gate, a switch, an application specific integrated circuit (ASIC), a programmable logic controller, and an embedded microcontroller. The processor can read and execute the program instruction or module in the memory.

The transmission module can be configured to perform data transmission via a network such as the Internet, an intranet, a local area network, or a mobile communications network.

It is worthwhile to note that the implementations in the present specification are described in a progressive way. For same or similar parts of the implementations, references can be made to the implementations mutually. Each implementation focuses on a difference from other implementations. In particular, the apparatus implementation and the electronic device implementation are basically similar to the data processing method implementation, and therefore are described briefly; for related parts, references can be made to the related descriptions in the data processing method implementation.

In addition, it can be understood that, after reading the present specification document, a person skilled in the art can figure out any combination of some or all of the implementations enumerated in the present specification without creative efforts, and these combinations also fall within the disclosure and protection scopes of the present specification.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, at present, instead of manually manufacturing an integrated chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog2 are most commonly used. A person skilled in the art should also understand that a hardware circuit that implements a logical method procedure can be readily obtained once the method procedure is logically programmed by using the several described hardware description languages and is programmed into an integrated circuit.

The system, apparatus, module, or unit illustrated in the previous implementations can be implemented by using a computer chip or an entity, or can be implemented by using a product having a certain function. A typical implementation device is a computer. Specifically, the computer can be, for example, a personal computer, a laptop computer, a cellular phone, a camera phone, a smart phone, a personal digital assistant, a media player, a navigation device, an e-mail device, a game console, a tablet computer, a wearable device, or a combination of any of these devices.

It can be seen from the descriptions of the implementations that a person skilled in the art can clearly understand that the present specification can be implemented by using software and a necessary general hardware platform. Based on such an understanding, the technical solutions in the present specification essentially or the part contributing to the existing technology can be implemented in a form of a software product. The computer software product can be stored in a storage medium, such as a ROM/RAM, a magnetic disk, or an optical disc, and includes several instructions for instructing a computer device (can be a personal computer, a server, or a network device) to perform the methods described in the implementations or in some parts of the implementations of the present specification.

The implementations in the present specification are described in a progressive way. For same or similar parts of the implementations, references can be made to the implementations mutually. Each implementation focuses on a difference from other implementations. Particularly, a system implementation is similar to a method implementation, and therefore is described briefly. For related parts, references can be made to related descriptions in the method implementation.

The present specification can be applied to many general-purpose or dedicated computer system environments or configurations, for example, a personal computer, a server computer, a handheld device or a portable device, a tablet device, a multi-processor system, a microprocessor-based system, a set-top box, a programmable consumer electronic device, a network PC, a minicomputer, a mainframe computer, and a distributed computing environment including any one of the previous systems or devices.

The present specification can be described in the general context of computer-executable instructions, for example, a program module. Generally, the program module includes a routine, a program, an object, a component, a data structure, etc. executing a specific task or implementing a specific abstract data type. The present specification can alternatively be practiced in distributed computing environments in which tasks are performed by remote processing devices that are connected through a communications network. In a distributed computing environment, the program module can be located in both local and remote computer storage media including storage devices.

Although the present specification is described by using the implementations, a person of ordinary skill in the art knows that many variations of the present specification can be made without departing from the spirit of the present specification. It is expected that the appended claims include these variations without departing from the spirit of the present specification.

1. A computer-implemented method for obtaining a data-based prediction result comprising:
accessing one or more nodes comprising a decision tree within an original decision forest supported by at least one first computing device, wherein the original decision forest is a data structure comprising one or more decision trees, wherein each decision tree of the original decision forest comprises a corresponding machine learning model;
keeping a splitting condition corresponding to a splitting node of a decision tree in an original decision forest unchanged;
encrypting a leaf value corresponding to a first leaf node of the decision tree in the original decision forest by using a homomorphic encryption algorithm, to obtain a second leaf node within an encryption decision forest;
sending the encryption decision forest to at least one second computing device;
receiving, by the at least one first computing device from the at least one second computing device, data corresponding to a target leaf node; and
obtaining the data-based prediction result of the decision tree from the data corresponding to the target leaf node.

2. The method of claim 1, wherein a splitting node of the decision tree in the original decision forest corresponds to plaintext data of the splitting condition and wherein the second leaf node of the decision tree in the encryption decision forest corresponds to ciphertext data.

3. The method of claim 1, wherein at least one decision tree in the original decision forest is a non-full binary tree, the method further comprising:
adding an additional node to the decision tree of the non-full binary tree so that the decision tree forms a full binary tree.

4. The method of claim 1, further comprising adding an additional decision tree to the original decision forest before sending the encryption decision forest to the at least one second computing device.

5. The method of claim 1, wherein receiving, by the at least one first computing device from the at least one second computing device, data corresponding to the target leaf node comprises:
receiving ciphertext data corresponding to the target leaf node by the at least one first computing device from the at least one second computing device, wherein the target leaf node is identified within the encryption decision forest by the at least one second computing device and wherein the ciphertext data corresponding to the target leaf node contains the data-based prediction result.

6. The method of claim 1, wherein receiving, by the at least one first computing device from the at least one second computing device, data corresponding to the target leaf node comprises:
receiving, by the at least one first computing device from the at least one second computing device, a first summation result, wherein the first summation result is obtained by the at least one second computing device summing ciphertext data of the target leaf node and noise data.

7. The method of claim 1, receiving, by the at least one first computing device from the at least one second computing device, data corresponding to the target leaf node comprises:
receiving, by the at least one first computing device from the at least one second computing device, a second summation result, wherein the second summation result is obtained by the at least one second computing device summing ciphertext data corresponding to multiple target leaf nodes.

8. A non-transitory, computer-readable medium storing one or more instructions executable by a computer system to perform operations for obtaining a data-based prediction result, wherein the operations comprise:
accessing one or more nodes comprising a decision tree within an original decision forest, wherein the original decision forest is a data structure comprising one or more decision trees, wherein each decision tree of the original decision forest comprises a corresponding machine learning model;
keeping a splitting condition corresponding to a splitting node of a decision tree in an original decision forest unchanged;
encrypting a leaf value corresponding to a first leaf node of the decision tree in the original decision forest by using a homomorphic encryption algorithm, to obtain a second leaf node within an encryption decision forest;
sending the encryption decision forest to at least one second computing device;
receiving, from the at least one second computing device, data corresponding to a target leaf node; and
obtaining the data-based prediction result of the decision tree from the data corresponding to the target leaf node.

9. The non-transitory, computer-readable medium of claim 8, wherein a splitting node of the decision tree in the original decision forest corresponds to plaintext data of the splitting condition and wherein the second leaf node of the decision tree in the encryption decision forest corresponds to ciphertext data.

10. The non-transitory, computer-readable medium of claim 8, wherein at least one decision tree in the original decision forest is a non-full binary tree, further comprising:
adding an additional node to the decision tree of the non-full binary tree so that the decision tree forms a full binary tree.

11. The non-transitory, computer-readable medium of claim 8, further comprising adding an additional decision tree to the original decision forest before sending the encryption decision forest to the at least one second computing device.

12. The non-transitory, computer-readable medium of claim 8, wherein receiving, from the at least one second computing device, data corresponding to the target leaf node comprises:
receiving ciphertext data corresponding to the target leaf node from the at least one second computing device, wherein the target leaf node is identified within the encryption decision forest by the at least one second computing device and wherein the ciphertext data corresponding to the target leaf node contains the data-based prediction result.

13. The non-transitory, computer-readable medium of claim 8, wherein receiving, from the at least one second computing device, data corresponding to the target leaf node comprises:
receiving, from the at least one second computing device, a first summation result, wherein the first summation result is obtained by the at least one second computing device summing ciphertext data of the target leaf node and noise data.

14. The non-transitory, computer-readable medium of claim 8, wherein receiving, from the at least one second computing device, data corresponding to the target leaf node comprises:
receiving, from the at least one second computing device, a second summation result, wherein the second summation result is obtained by the at least one second computing device summing ciphertext data corresponding to multiple target leaf nodes.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations for obtaining a data-based prediction result, wherein the operations comprise:
accessing one or more nodes comprising a decision tree within an original decision forest, wherein the original decision forest is a data structure comprising one or more decision trees, wherein each decision tree of the original decision forest comprises a corresponding machine learning model;
keeping a splitting condition corresponding to a splitting node of a decision tree in an original decision forest unchanged;
encrypting a leaf value corresponding to a first leaf node of the decision tree in the original decision forest by using a homomorphic encryption algorithm, to obtain a second leaf node within an encryption decision forest;
sending the encryption decision forest to at least one second computing device;
receiving, from the at least one second computing device, data corresponding to a target leaf node; and
obtaining the data-based prediction result of the decision tree from the data corresponding to the target leaf node.

16. The computer-implemented system of claim 15, wherein a splitting node of the decision tree in the original decision forest corresponds to plaintext data of the splitting condition and wherein the second leaf node of the decision tree in the encrypted decision forest corresponds to ciphertext data.

17. The computer-implemented system of claim 15, wherein at least one decision tree in the original decision forest is a non-full binary tree, further comprising:
adding an additional node to the decision tree of the non-full binary tree so that the decision tree forms a full binary tree.

18. The computer-implemented system of claim 15, further comprising adding an additional decision tree to the original decision forest before sending the encryption decision forest to the at least one second computing device.

19. The computer-implemented system of claim 15, wherein receiving, from the at least one second computing device, data corresponding to the target leaf node comprises:
receiving ciphertext data corresponding to the target leaf node from the at least one second computing device, wherein the target leaf node is identified within the encryption decision forest by the at least one second computing device and wherein the ciphertext data corresponding to the target leaf node contains the data-based prediction result.

20. The computer-implemented system of claim 15, wherein receiving, from the at least one second computing device, data corresponding to the target leaf node comprises:
receiving, from the at least one second computing device, a first summation result, wherein the first summation result is obtained by the at least one second computing device summing ciphertext data of the target leaf node and noise data.
